(19) United States
(12) Patent Application Publication
(10) Pub. No.: US 2021/0029992 A1
(43) Pub. Date: Feb. 4, 2021

(54) PERSONAL PROTECTIVE EQUIPMENT

(71) Applicant: First Step Holdings, LLC, Tucson, AZ (US)

(72) Inventors: Jeffry Brian SKIBA, Chandler, AZ (US); Scott N. SHEFTEL, Tucson, AZ (US)

(21) Appl. No.: 17/073,261

(22) Filed: Oct. 16, 2020

Related U.S. Application Data
(63) Continuation-in-part of application No. 15/823,076, filed on Nov. 27, 2017.
(60) Provisional application No. 63/090,221, filed on Oct. 10, 2020.

(51) Int. Cl. A01N 25/34; A41D 31/30; A01N 59/16

(52) U.S. Cl. CPC A01N 25/34; A01N 59/16; A41D 31/305

(57) ABSTRACT

An antimicrobial fabric formed of thermoplastic fibers containing nano-sized particles of zinc.

### CROSS REFERENCE TO RELATED APPLICATION

This application is a continuation-in-part (CIP) of our co-pending U.S. patent application Ser. No. 15/823,076, filed Nov. 27, 2017, and also claims priority to our co-pending provisional application Ser. No. 63/090,221, filed Oct. 10, 2020, the contents of which are incorporated herein by reference.

### BACKGROUND OF THE INVENTION

The present invention relates to anti-microbial, antiviral, fibers, fabrics and to devices made from said fabrics. The invention has particular utility in connection with personal protective equipment (PPE's) such as surgical masks and respirators, and will be described in connection with such utilities, although other utilities are contemplated.

Surgical masks and respirators mitigate the spread of infectious diseases including, but not limited to the common cold, influenza, SARS, H1N1 Swine Flu, and most recently, COVID-19, also known as “coronavirus.” Surgical masks and respirators and masks are designed to reduce the spread of airborne illnesses by providing a physical filter between facial regions of the wearer's and the wearer's ambient environment. Surgical masks are less effective than respirators, which provide a tighter seal around the nose and mouth and provide better air filtration. Surgical masks are also less effective than respirators at reducing the spread of viral or other microbial infections via aerosolized particles, making them a risky form of personal protective equipment for health care providers dealing with influenza, COVID-19, and other infectious microbes. Effective prevention of the spread of airborne illnesses is particularly important for healthcare providers and first responders, who frequently come into contact with infected and non-infected patients.

Common masks used by non-medical professionals, i.e., paper or cloth masks, which are only partially effective at reducing the spread of viral or other pathogen infection through inhalation and exhalation. Paper masks are not regulated and while they have been established as more effective than no barrier, their efficacy is variable, with only 30-50% barrier efficacy in some instances, which may provide users a false sense of security leading them to acquire or spread infection. Unregulated paper masks typically are not multi-ply and do not provide respiratory protection. Paper masks are mainly useful at preventing the user from touching the area around their nose and mouth, and are only marginally useful for preventing a patient from contracting infection or from preventing an infected patient from spreading infection. Nevertheless, for aerosolized virus, they offer better air filtration of viral pathogens than no mask at all. During times of pandemic when personal protective gear must be rationed due to high demand, the need for a continuous supply of replacement masks places financial and medical strains on the health care system.

Surgical masks are loose-fitting and disposable, and often wrap around the ears to cover just the nose and mouth. Most surgical masks are multi-ply, providing better filtration than paper and cloth or homemade masks. Some surgical masks have an additional face shield. Surgical masks are regulated, unlike cloth or paper masks, and reduce the risk of contracting or spreading infection by filtering out a degree of small particles such as viruses. Surgical masks are used by doctors, surgeons, and dentists during medical procedures for maintaining a sterile procedure and preventing fluid transmission between healthcare providers and patients. However, there is still risk of infection transfer as surgical masks have been shown to have reduced efficacy reportedly around 80% of particles for air filtration, which aids in preventing the spread of viral pathogens either via exhalation or inhalation. Surgical masks also serve as a barrier to liquid splashes including saliva. However, surgical masks do not cover eyes to prevent ocular transmission of aerosolized pathogens. Surgical masks are frequently worn in East Asian culture, including in Japan and Taiwan, to reduce the risk of spreading infection and as a sign of social responsibility to alert others that the person may be infectious.

Respirators provide further protection against bilateral spread of infection preventing the wearer from being exposed to infection and preventing an infected person from exposing others. The most common respirators are disposable N95-NI00 respirator masks. Respirators under optimal circumstances are designed to be tight-fitting around the nose and mouth area and filter out small particles including virus. Respirators, when perfectly fitting, may filter out 95%-100% of airborne particles as small as 0.3 microns. Respirators, in conjunction with other personal protective equipment are highly effective at reducing the spread of viral and bacterial pathogens and commonly used by research and medical professionals. However, there are inherent limitations of the effectiveness of the masks when used by wearers who have facial hair, who experience perspiration on the face that limits the occlusive fit of the mask, or who's facial shape does not allow a perfect or secure fit. Furthermore, in the case of COVID 19 the virus is extremely tiny (less than 0.2 microns) making an adjunctive means of anti-microbial activity in a mask more important. Additionally, as mask efficiency is increased, e.g., through use of additional or thicker or tighter layers, the pressure required to pull air through the mask is increased. Pressure also increases as the layers become loaded with particles. Filter designs which include tortuous pathways which slow particle velocity and/or trapping of particles also increase pressure. Improving the antimicrobial milieu of the breathing chamber in a mask may help overcome the limitations of an imperfect respirator and improve the antimicrobial environment of a face shield.

Furthermore, some respirators, including N95 masks, are disposable, in order to eliminate the opportunity for daily contamination when exposed to infected persons or patients, and to avoid the potential spread of infection between health care providers with each other or spreading infection between patients. It is assumed respirators become contaminated when doctors come into contact with infected patients, particularly for aerosolized types of infection-or when worn by an infected person. Unfortunately, in the event of a shortage of personal protective equipment, including face masks, healthcare providers and first responders are forced to reuse face masks, increasing the likelihood of becoming infected themselves and of spreading infection to others. Conventional respirators when worn properly by a person infected with viral, bacterial, or fungal pathogens decrease the spread of their droplets by keeping them trapped in the face cup. However, these devices do nothing to decrease the level of infectious pathogens already present on skin or viral reservoirs in an infected patient's nasal or oral cavities. In fact, face masks on an infected person in some instances may actually create the moist environment that could increase viral replication.

Furthermore, face masks and respirator N-95-I 00 masks which are disposable and easily contaminated, require large volumes of equipment to maintain supply in times of pandemic, causing shortages and limiting public access to these items in order to necessarily maintain the health and protection of health care providers and other essential workers.

### SUMMARY OF THE INVENTION

In our parent U.S. application Ser. No. 15/823,076, we describe a method for producing metal particle filled fibers by dispersing metal particles throughout the fibers during fiber production, and to metal particle filled fibers produced thereby. Preferably, the metal particles include zinc particles, zinc oxide particles, or zinc salt particles, having a particle sized range of 1 micron-200 microns. The metal filled fibers may then be used to form fabric devices for treating hyperhidrosis and other conditions such as neuropathic pain including peripheral artery disease and neuropathy; surgical rehabilitation and surgical convalescence including joint surgery, rehabilitation and soft tissue healing; and physical therapy including muscle and tendon headlong and stroke rehabilitation by applying onto a skin surface of a patient in need of such treatment, a device comprising a fabric or substrate containing elemental zinc particles arranged so that the fabric or substrate forms a plurality of half-cells of an air-zinc battery, whereby to produce an ion exchange with the skin of the patient. Zinc, zinc oxide or zinc salt particles against the skin will result in secondary reactions to form zinc complexes beneficial to the host. The ability to deliver topical zinc to the surface of the skin can have beneficial effects provided the zinc particles are in the correct physical arrangement.

Additionally, the therapeutic value of metals and metal salts such as zinc, zinc oxide and zinc salt in cosmetic and medicinal ointments and creams, i.e., for treating a variety of skin conditions is well documented in the art. However, one of the limitations of creams or ointments is that they require a carrier gel or petrolatum, and these carriers create barriers on the skin, potentially trapping microbes beneath the barriers.

We have now found that fibers containing nano size zinc particles for forming fabrics incorporated into personal protective equipment such as masks, provide an anti-microbial kill rate in excess of 99% when in close proximity to the skin of a human or other animal. This is expected since micron size particles of zinc as disclosed in our aforesaid PCT application and other a prior art has no effect reported as antimicrobials. While not wishing to be bound by theory, it is believed that as the zinc particles approach <100 nanometers in size, quantum effects being to apply substantially increasing surface energies which result in kill rates of microbes not seen with large size particles. More particularly, we have found that fibers containing nano-size particles of zinc, preferably 1 to 10,000 nanometers, even more preferably 1 to 1000 nanometers sized particles have a kill rate in excess of 99% against various microbes or pathogens, including but not limited to viruses causing the common cold, influenza, SARS, H1N1(swine flu) and COVID-19, as well as bacteria, algae, fungi, molds, yeasts, etc. This is unexpected since larger size zinc particles incorporated into fibers does not provide it is similar anti-microbial properties.

Preferably with the fiber material a comprises thermoplastic polymer, preferably polyethylene, although polypropylene or other thermoplastic polymer materials may be used. Preferably the zinc-nano particles are incorporated into the polymer fibers on formation of the fiber. In order to strengthen the fiber, carbon nanotubes are included in the fiber during fiber formation.

### BRIEF DESCRIPTION OF THE DRAWINGS

Further features and advantages of the present invention will be seen from the following detailed description, taken in conjunction with the accompanying drawings, wherein like numerals depict like parts, and wherein:

FIG. 1 is a flow diagram showing a preferred method of forming nano particle size metal particles filled fibers in accordance with the present invention;

FIG. 2 is a view similar to FIG. 1 of an alternative method for forming nano particle size metal particles filled fibers in accordance with the present invention;

FIG. 3 is a side elevational view of monofilaments fiber made accordance with the present invention;

FIG. 4 is a plan view of a surgical mask formed in accordance with the present invention; and

FIG. 5 is a plain view showing various articles of personal protective equipment made in accordance with the present invention.

### DETAILED DESCRIPTION OF THE INVENTION

As used herein the term “microbe” or “pathogen”, which are used interchangeably, may include bacteria, algae, fungi, molds, yeasts, and viruses including but not limited to the common cold, influenza, SARS, H1N1, Swine Flu and COVID-19 commonly know as “Coronavirus”.

“Personal protective equipment” or PPE may include masks, scrubs, respirators, caps and other headgear such as face shields, and other types of clothing as well as sheets, pillowcases, and the like.

“Metal particles” may include elemental zinc particles and oxides and salts thereof.

“Fibers” include natural and artificial fibers, preferably thermoplastic fiber materials more preferably, polyethylene.

And “metal filled fibers” means fibers, having metal particles carried on or within the fibers, and in which at least some of the metal particles are at least in part exposed to air.

The present invention in one aspect provides a method forming nano-sized metal particle filled fibers suitable for weaving or knitting into a fabric for use in forming personal protective equipment. More particularly, the present invention provides a method for producing nano-sized metal particle containing fibers that are capable of forming metal-air electrochemical cells, capable of releasing ions when adjacent or in contact with a patient's skin or moisture.

The metal particle fiber matrix interacts with exhaled moisture and oxygen, or moisture and oxygen from the wearer's skin surface, to generate a microcurrent. A sustainable electric current is created without an external battery source, which destrous virulent microbes or pathogens including Coronavirus.

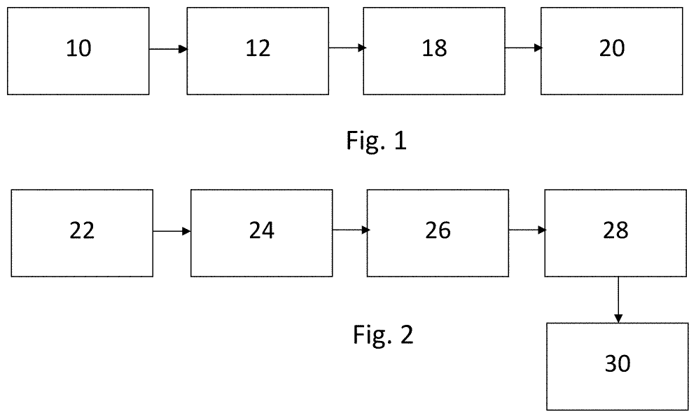

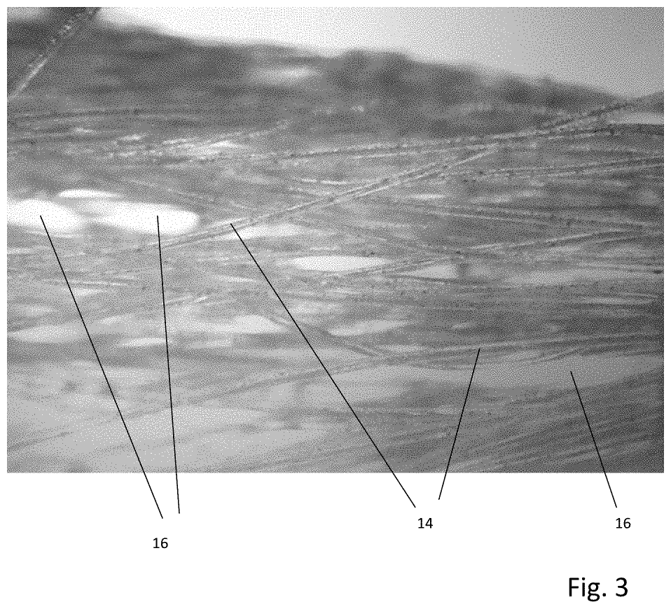

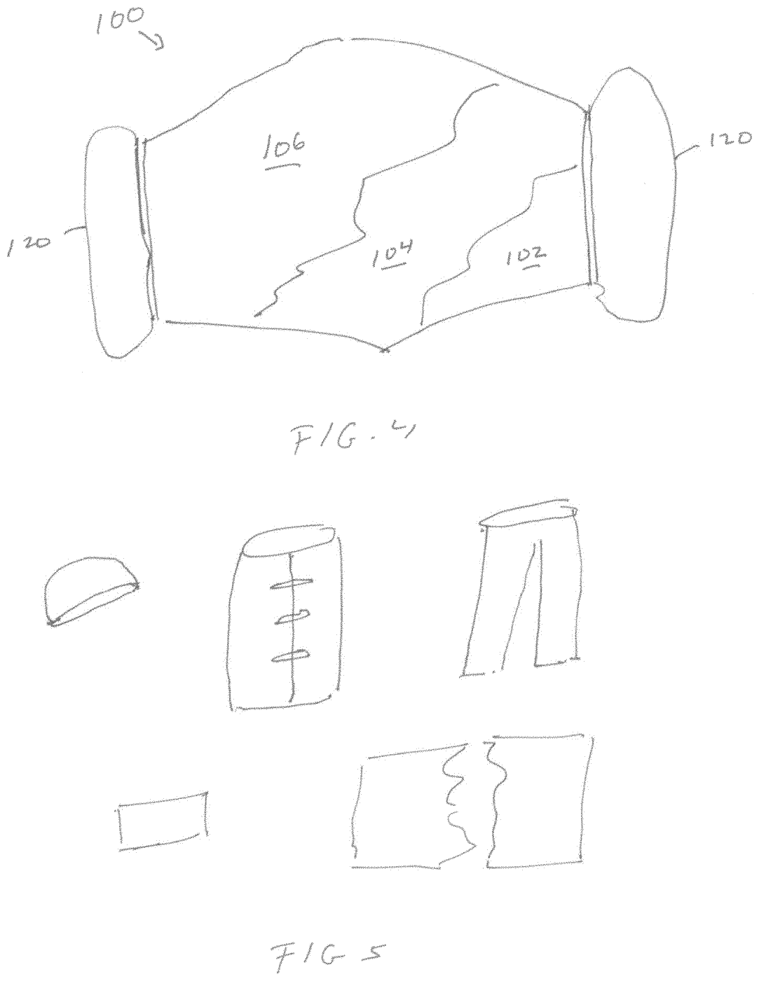

Referring to FIG. 1, according to a first embodiment of our invention, metal particles, typically metallic zinc particles which may be previously formed by grinding or precipitated out of suspension, and having an average particle size between 1 and 10,000 nanometers, more preferably 1000 to 6000 nanometers, even more preferably about 4000 to 6000 nanometers, most preferably 1 to 1000 nanometers are mixed with a thermoplastic material such as polyethylene in a heated mixing vat 10 to melt the thermoplastic material, and the mixture bump extruded or melt spun at spinning station 12 to form fibers 14, having nanometer size metal particles 16 (see FIG. 3). Polyethylene is the polymer of choice for releasing of electrons from the metal. The porosity of the fiber also is believed to play a part. Polyacrylic or polyester fibers also may be used; however polyacrylic or polyester fibers result is a slower ion release. The nanometer sized metal particles filled fibers may then be cabled or twisted at a cabling station 18, and woven at a weaving or knitting station 20, or laid in a non-woven manner, into a fabric which is then used to form personal protective equipment such as a mask (FIG. 4) as described below, or made into a hospital scrub or cap, or a sheet, pillow case, etc., as shown in FIG. 5.

Referring to FIG. 2, according to a second embodiment of the invention, nanosized metallic zinc particles having an average particle size between 1 and 10,000 nanometers, preferably 1000 to 6000 nanometers, even more preferably about 4000 to 6000 nanometers, most preferably 1 to 1000 nanometers are mixed with a thermosetting polymer material such as polyester chips in a melting vat 22. The molten mixture is expressed through a spinneret at station 24 to form an elongate thread having metal particles incorporated into the thread with the metal particles exposed at least in part on the surface of the thread. The thread is then cabled or twisted at a cabling station 26, woven into cloth at a weaving station 28, and the cloth with metal-free threads or cables formed into personal protective equipment at step 30.

FIG. 4 illustrates a mask made in accordance with the present invention. As shown, mask 100 comprises an outer cloth layer 102, a middle cloth layer 104 and an inner cloth layer 106. Outer layer 102 and middle layer 104 are formed of a conventional cloth. Inner layer 106 comprises a fabric having a plurality of spaced metal deposition areas 120. As shown, the plurality of individual metal deposition areas 120 are discontinuous and uniformly distributed on the surface of the fabric 106, in imaginary spaced lines or lines of dots, to cover a substantially consistent percentage of the surface area of the fabric 106. Typically, the lines or lines of dots are evenly spaced at spacings from 0.1 to 3 mm, preferably 0.2 to 2 mm, more preferably 0.3 to 1.5 mm, most preferably 0.5 to 1.0 mm. The concentration of zinc particles in the threads that form the line or deposition determines the amount of zinc available for forming an air-zinc battery as will be described below. Preferred concentration is 30% but the lowest is about 1% and the highest about 50%. In certain embodiments, the metal deposition area patterns 120 cover from about 10% to about 90% of the surface area of the fabric layer 106. In other embodiments, the metal deposition areas 120 cover from about 20% to about 80%, from about 15% to about 75%, from about 25% to about 50%, or from about 30% to about 40% of the surface area of the fabric layer 106. Although FIG. 4 shows the plurality of metal deposition areas 120 substantially uniformly distributed on the surface of the fabric layer 106, in other embodiments, the plurality of metal deposition areas 120 may be randomly distributed on the surface of the fabric layer 106. Typically, the lines have a thickness of 0.1 to 3 mm, preferably 0.2 to 2 mm, more preferably 0.3 to 1.0, most preferably 0.4 to 0.5 mm. The spaced lines may be continuous and may take various forms including straight, curved and various angular shapes depending on the weave. The actual shape of the lines is not important. Preferably, but not necessarily, the lines are approximately equal in thickness and are evenly spaced.

The mask 100, as illustrated in FIG. 4, comprises a three-layer fabric mask, but alternatively may comprise two, or four or more layers of fabric including the fabric layer containing the metal nano-particles forming the innermost surface or layer of the mask. Alternatively, the metal nano-particles containing a fabric may be formed as filter insert or element on the innermost surface or layer of the mask.

Completing the mask are fasteners such as ear straps or head straps 120 configured to attach the mask to the head of the wearer.

The present invention is unique in that the zinc pattern grid on the tactile layer creates a matrix of individual half-cells (anodes) for ion exchange with the skin of the wearer which effectively kills microbes on or adjacent the skin of the wearer or between the skin and the tactile layer. One-half cell of electrochemical reaction is the zinc impregnated fabric (the anode), and the other is the skin of the wearer, with the breath of the wearer or moisture from the skin of the wearer, supplying moisture and oxygen (the cathode) completing the circuit for microcurrent production. Alternatively, the oxygen may be supplied, in part, from ambient air.

There results a Zinc-air battery powered by oxidizing zinc with oxygen from the air. During discharge, zinc particles form a porous anode, which is saturated with an electrolyte, namely moisture from the breath or skin of the wearer. Oxygen from the air reacts at the cathode and forms hydroxyl ions which migrate into the zinc paste and form zinc hydroxide Zn(OH)₂, releasing electrons to travel to the cathode.

The chemical equations for the zinc-air battery formed using Applicants' zinc-coated masks and ambient oxygen are as follows:

Anode: Zn+4OH⁻→Zn(OH)₄²⁻+2e⁻(E₀=−1.25 V)

Fluid: Zn(OH)₄²⁻→ZnO+H₂O+2OH⁻

Cathode: ½O₂+H₂O+2e⁻→2OH⁻(E₀=0.34 V)

Overall, the zinc oxygen redox chemistry recited immediately hereinabove comprises an overall standard electrode potential of about 1.59 Volts.

There is a certain amount of gas exchange at the skin surface with a partial pressure of oxygen. The oxygen at the skin surface is a product of ambient oxygen in addition to oxygen diffusion from capillary blood flow. In certain embodiments, the zinc in contact with a patient's skin or breath resulting from wearing, for example, our zinc-containing mask, in combination with moisture from the skin or breath of the wearer and transcutaneous oxygen complete the galvanic circuit described hereinabove.

The chemistry utilized by Applicants' zinc-coated mask differs from a more conventional galvanic cell. A galvanic cell, or voltaic cell is an electrochemical cell that derives electrical energy from spontaneous redox reactions taking place within the cell. It generally consists of two different metals connected by a salt bridge, or individual half-cells separated by a porous membrane. In contrast, the chemistry of Applicants' zinc-air battery does not require use of a second metal. Applicants' device acts as a powerful antimicrobial exhibiting a kill rate in excess of 99%.

The fabric is configured to contact the skin or breath of the wearer and to generate an electric current and metal ions when oxidized by ambient oxygen. The generation of such an electric current kills microbes in the vicinity. Another added advantage is that the zinc-air battery may reduce mask rash.

The fabric described herein also may be used in the manufacture of various personal protective equipment such as scrubs, caps, etc., as well as various closing items as well as sheets, pillow cases, etc. FIG. 5 shows various examples of personal protective equipment made in accordance with the present invention including hospital gowns, caps, as well as sheets and pillow cases, etc.

Various changes may be made in the above invention without departing from the spirit and scope. For example, the fibers may be co-extruded to have a center or core of the same or dissimilar polymer with the metal filled polymer on the outside of the fiber. Co-extrusion has the advantage that the center of the fiber is void of metal and therefore can contribute more strength to the fiber, while the outer layer may be loaded with metal particles. Or, the metal filled polymer may be intermittently dispersed into discrete reservoirs within the fiber during fiber formation. And, of carbon fiber nanotubes (hollow-tubes) can be added to provide increased tensile strength as well as the antimicrobial nature of the hollow tubes. Also, the amount of metal particles in the fibers may be adjusted to adjust the capacity or voltage of the air battery in the thread or yarn.

1. An antimicrobial fabric formed of thermoplastic fibers containing nano-sized particles of zinc.

2. The fabric of claim 1, wherein the fibers contain carbon nanotubes dispersed intermittently within the thermoplastic fibers during fiber formation, and wherein the particles of zinc are selected from the group consisting of elemental zinc particles, zinc oxide and zinc salt.

3. The fabric of claim 1, wherein the zinc particles have a size range of 1 to 10,000 nanometers, preferably 1000 to 6000 nanometers, more preferably 4000 to 6000 nanometers, most preferably 1 to 1000 nanometers.

4. The fabric of claim 1, wherein the nano-size particles of zinc are exposed at least in part on a surface of the thermoplastic fibers.

5. The fabric of claim 1, wherein the thermoplastic fibers comprise polyethylene fibers or polypropylene fibers.

6. The fabric of claim 1, wherein the fibers are formed by co-extruding polyethylene fibers with a core fiber formed of the same or a different thermoplastic material or with a thermosetting material.

7. Personal protective equipment formed at least in part of fabric as claimed in claim 1, wherein a surface of the fabric is comprised to be in direct contact with the skin of the wearer, at least in part, when worn, and wherein the particles are arranged so that the fabric in contact with the skin of the wearer forms a plurality of half-calls of an air-zinc battery.

8. The personal protective equipment of claim 7, in the form of a mask.

9. The personal protective equipment of claim 7, in the form of scrubs or caps.

10. The personal protective equipment of claim 6, in the form of sheets or pillow covers.
